(19) United States
(12) Patent Application Publication
(10) Pub. No.: US 2022/0123563 A1
(43) Pub. Date: Apr. 21, 2022

(54) Dual Battery Power System

(71) Applicant: Daniel Garcia, DES PLAINES, IL (US)

(72) Inventor: Daniel Garcia, DES PLAINES, IL (US)

(21) Appl. No.: 17/503,987

(22) Filed: Oct. 18, 2021

Related U.S. Application Data
(60) Provisional application No. 63/092,655, filed on Oct. 16, 2020.

(51) Int. Cl. H02J 7/00

(52) U.S. Cl. CPC H02J 7/0019; H02J 7/0024; H02J 7/0049; H02J 7/00034; H02J 7/0031

(57) ABSTRACT

A dual battery power system for electronic devices is provided. The system includes a first battery operably connected to an electronic device. A second battery is electrically connected to the first battery via a bridging device, wherein the bridging device comprises a switch selectively moveable between an open state and a dosed state. The switch is actuated to the dosed state upon detection of a predefined condition by the bridging device. Upon actuation of the switch to the dosed state, energy stored within the second batter is transferred to the first battery. In some embodiments, an application is installed on the electronic device, wherein the application includes a plurality of controls to set additional predefined conditions.

### CROSS REFERENCE TO RELATED APPLICATIONS

This application claims the benefit of U.S. Provisional Application No. 63/092,655 filed on Oct. 16, 2020. The above identified patent application is herein incorporated by reference in its entirety to provide continuity of disclosure.

### BACKGROUND OF THE INVENTION

The present invention relates to electronic device power systems. More particularly, the present invention pertains to an electronic device power system having two batteries, wherein the second battery selectively recharges the first battery upon detection of a preset condition to extend effective battery life of the electronic device.

Many individuals use portable electronic devices or other electronic devices that rely on battery power to operate. These devices frequently expend the charge within the battery after periods of prolonged use, thereby rendering the device unusable until the device is recharged. This can be frustrating and difficult for users that rely on their electronic devices throughout the day to perform work tasks or receive important messages and calls. Should the device lose charge, the user can miss important calls, messages, texts, emails, and the like. This can lead to several problems that cannot be corrected until the device is recharged, usually at the end of the day when the user returns home. Therefore, a device that allows a user to extend the battery life of their electronic devices while away from a means of recharging the device is desired.

In light of the devices disclosed in the known art, it is submitted that the present invention substantially diverges in design elements from the known art and consequently it is clear that there is a need in the art for an improvement to existing electronic device power systems. In this regard, the instant invention substantially fulfills these needs.

### SUMMARY OF THE INVENTION

In view of the foregoing disadvantages inherent in the known types of electronic device power systems now present in the known art, the present invention provides a dual battery power system wherein the same can be utilized for providing convenience for the user when extending the functional battery life of an existing electronic device.

The present system comprises a first battery operably connected to an electronic device. A second battery is electrically connected to the first battery via a bridging device, wherein the bridging device comprises a switch selectively movable between an open state and a closed state. The switch is actuated to the closed state upon detection of a predefined condition by the bridging device, whereupon actuation of the switch to the closed state, energy stored within the second battery is transferred to the first battery. In some embodiments, an application is installed on the electronic device, wherein the application includes a plurality of controls configured to set additional predefined conditions.

In some embodiments, the predefined condition is selected from a group consisting of placement of the electronic device into an idle state, placement of the electronic device into a deactivated state, and detection of energy storage within the first battery falling below a defined threshold. In another embodiment, a charging port is operably connected to the first battery, such that energy is transferred to the first battery from an external power source via the charging port. In other embodiments, the bridging device further comprises a second switch selectively movable between an open state and a closed state, wherein the second switch is actuated to the closed state when the first battery is at capacity and the charging port is active to transfer energy from the first battery to the second battery. In yet another embodiment, the charging port is further operably connected to the second battery, such that energy transferred from the external power source is equally distributed to each of the first battery and the second battery. In some embodiments, the plurality of controls includes a first battery energy threshold control, a timer control, and an idle control. In another embodiment, the timer control defines a set time period during which the switch is actuated to the dosed state to transfer energy to the first battery. In other embodiments, the application further displays a current charge level of each of the first battery and the second battery.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a schematic view of an embodiment of the dual battery power system.

FIG. 2 shows a perspective view of an application interface of an embodiment of the dual battery power system.

### DETAILED DESCRIPTION OF THE INVENTION

Reference is made herein to the attached drawings. Like reference numerals are used throughout the drawings to depict like or similar elements of the dual battery power system. The figures are intended for representative purposes only and should not be considered to be limiting in any respect.

According to some embodiments, the operations, techniques, and/or components described herein can be implemented as (i) a special-purpose computing device having specialized hardware and a logic hardwired into the computing device to persistently perform the disclosed operations and/or techniques or (ii) a logic that is implementable on an electronic device having a general purpose hardware processor to execute the logic and a computer-readable medium, e.g. a memory, wherein implementation of the logic by the processor on the electronic device provides the electronic device with the function of a special-purpose computing device.

In the interests of economy, the present disclosure refers to “a computer-readable medium,” “a processor,” and so on. However, this should not be read as limiting in any way as the present disclosure contemplates embodiments of the present invention utilizing “one or more computer-readable media,” “one or more processors,” and so on. Unless specifically limited to a single unit, “a” is intended to be equivalent to “one or more” throughout the present disclosure.

As referred to herein, the term “electronic device” refers to any computing device that includes at least a display screen and an input mechanism. The computing devices can be hard-wired to perform the operations, techniques, and/or components described herein, or can include digital electronic devices such as one or more application-specific integrated circuits (ASICs) or field programmable gate arrays (FPGAs) that are persistently programmed to perform the operations, techniques and/or components described herein, or can include one or more general purpose hardware processors programmed to perform such features of the present disclosure pursuant to program instructions in firmware, memory, other storage, or a combination. Such computing devices can also combine custom hard-wired logic, ASICs, or FPGAs with custom programming to accomplish the technique and other features of the present disclosure. The computing devices can be desktop computer systems, laptops, cell phones, tablets, networking devices, or any other device that incorporates hard-wired and/or program logic to implement the techniques and other features of the present disclosure.

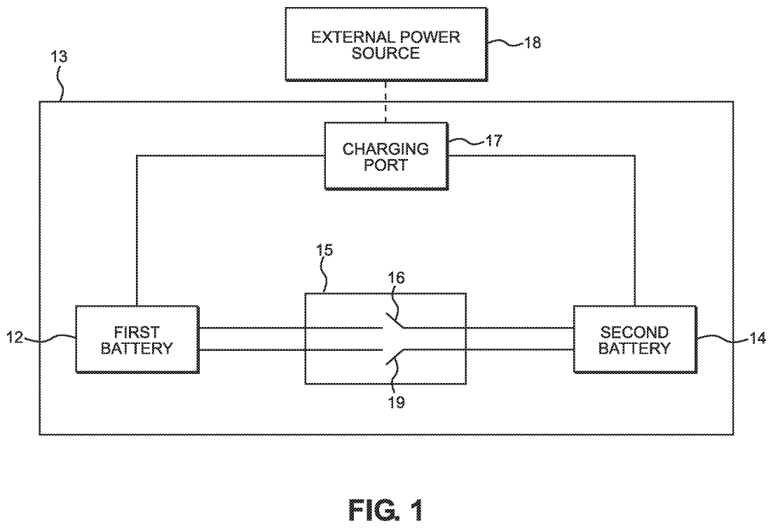

Referring now to FIG. 1, there is shown a schematic view of an embodiment of the dual battery power system. The dual battery power system comprises a first battery 12 operably connected to an electronic device 13, wherein the first, battery 12 is further operably connected to a second battery 14 via a bridging device 15. The electronic device 13 is contemplated to include a variety of electrically powered devices, including, but not limited to, cell phones, tablets, laptops, electric vehicles, and the like. In this manner, the dual battery power system is contemplated to be incorporated into existing electronic devices 13 to extend the longevity of the electronic device 13 between recharging the onboard power source. The present system separates the second battery 14 from the electronic device 13, ensuring that the energy stored within the second battery 14 is maintained at a constant storage amount until one of a variety of predefined conditions arises. Particularly, this arrangement is accomplished via at least one switch 16 disposed within the bridging device 15, wherein the switch 16 is selectively movable between an open configuration and a closed configuration, whereupon detection of a predefined condition, the switch 16 is configured to move to the closed configuration to transfer power stored within the second battery 14 to the first battery 12. In some embodiments, the predefined conditions are selected from a group consisting of placement, of the electronic device 13 into an idle state, placement of the electronic device 13 into a deactivated state, and detection of energy storage within the first battery 12 falling below a defined threshold. In this manner, the user can passively recharge the first battery 12 via the second battery 14 while the electronic device 13 not in use, thereby effectively operating as if the electronic device 13 is operably connected to an external power source 18 during these periods of downtime until both the first and second batteries 12, 14 are fully depleted. In some such embodiments, the bridging device 15 comprises a processor thereon, wherein the processor is configured to detect the presence of the predefined conditions and actuate the switch 16 into the closed configuration. In some embodiments, the user can define which of the predefined conditions actuates the switch 16, as well as the precise threshold energy storage level within the second battery 14 that actuates the switch 16. In this manner, the user can define when the first battery 12 is recharged via the energy stored within the second battery 14 to extend the effective lifetime of the electronic device 13 without access to an external power source 18. Alternatively, further conditions in which a user may wish to transfer energy from the second battery 14 to the first battery 12 may be incorporated to ensure that the electronic device 13 remains operational for an extended period of time.

The switch 16 is contemplated to comprise a variety of devices capable of opening and closing a connection between two electronic components, such as, but not limited to, a mechanical switch, a relay, a solid-state switching device, or the like. In some embodiments, the pathway defined between the first and second batteries 12, 14 is contemplated to comprise a unidirectional pathway, such that energy is driven only from the second battery 14 to the first battery 12 when the switch 16 is in a closed position. In the shown embodiment, the bridging device 15 further comprises a secondary pathway operably connecting the first battery 12 to the second battery 14, wherein the secondary pathway includes a second switch 19 configured to selectively move between an open position and a closed position as further described elsewhere herein. In this manner, the secondary pathway is configured to allow energy to pass from the first battery 12 to the second battery 14 when the second switch 19 is in the closed position.

In the illustrated embodiment, the electronic device 13 further comprises a charging port 17 operably connected to at least the first battery 12, wherein the charging port 17 can be operably connected to an external power source 18 to transfer energy to the first battery 12. In some embodiments, the charging port 17 is solely connected to the first battery 12, ensuring that the first battery 12 retains primacy regarding recharging priority. As such, the first battery 12 is fully charged before energy is stored in the second battery 14 such that the user can reduce inefficiencies caused by line losses in transferring power from the second battery 14 to the first battery 12 when the first battery 12 falls below the defined threshold. In such embodiments, the bridging device 15 comprises a secondary pathway having a second switch 19 thereon, wherein the second switch 19 is configured to selectively open or close to allow energy to the second battery 14 from the first battery 12. In some such embodiments, the bridging device 15 is configured to actuate the second switch 19 to the closed position upon detection of both a connection to the external power source 18 and the energy level of the first battery 12 being at maximum capacity. In this manner, the dual battery power system ensures that the first battery 12 recharges in its entirety before the second battery 14 is recharged, such that if the recharging process is interrupted, the first battery 12 retains sufficient charge to ensure continued operation of the electronic device 13 without potential energy losses due to transferring energy from the second battery 14. However, in other embodiments, the charging port 17 is operably connected to each of the first battery 12 and the second battery 14 to simultaneously charge the first and second batteries 12, 14.

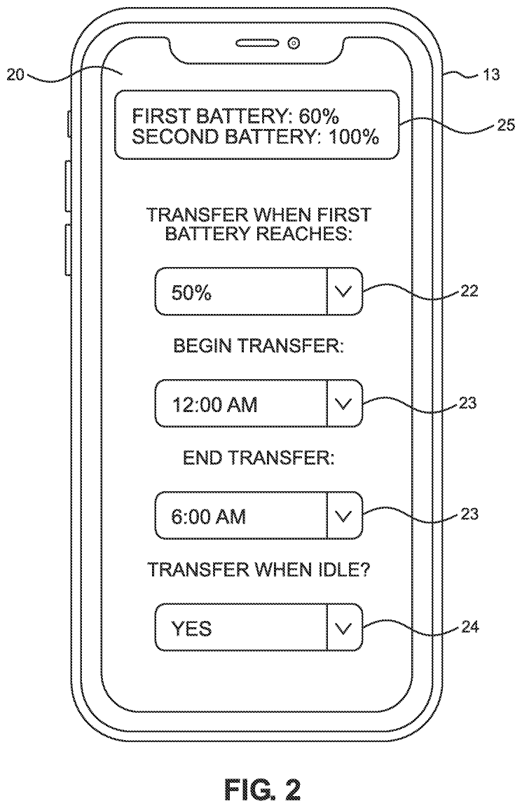

Referring now to FIG. 2, there is shown a perspective view of an application interface of an embodiment of the dual battery power system. In the shown embodiment, the dual battery power system further comprises an application 20 installed on the electronic device 13, wherein the application 20 comprises a plurality of controls thereon for adjusting the predefined conditions upon which the switch is moved to the closed position to transfer energy from the second battery to the first battery. In the illustrated embodiment, the application 20 is installed on a cell phone, however, as previously discussed, the electronic device 13 can comprise a variety of alternate devices having control systems capable of supporting the application 20, such as a dashboard control panel of an electric vehicle. Alternatively, the application 20 may be wirelessly connected to the dual battery power system, such that the user can remotely adjust the predefined conditions via a separate device having the application 20 installed thereon. In the shown embodiment, the plurality of controls include a first battery threshold control 22, wherein the first battery threshold control 22 is adjustable to define the amount of charge remaining within the first battery upon which the switch will be actuated to transfer energy to the first battery from the second battery. Furthermore, in the illustrated embodiment, the application 20 further comprises a timer control 23, wherein the timer control 23 selectively sets a period of time during which the switch is actuated to the closed configuration, such that the first battery recharges from the second battery within the range of time specified by the timer control 23. Additionally, an idle control 24 is disposed on the application 20, wherein the idle control 24 comprises a binary selector configured to actuate the switch to the closed position when the electronic device 13 is in an idle or deactivated state, such that during periods of disuse, the first battery recharged for future use. In some embodiments, the idle state can further be defined by an adjustable length of time without the electronic device 13 receiving an input. In some embodiments, additional controls may be present to define additional conditions upon which the switch will be actuated to the closed position to transfer energy from the second battery to the first battery. In the illustrated embodiment, the application 20 further comprises a battery display 25 indicating the energy level of each of the first and second batteries, such that the user is informed of the current charge remaining in each battery, thereby allowing the user to ascertain when the connect the electronic device 13 to the external power source.

In one use, the bridging device monitors the status of the electronic device 13 and each of the first and second batteries to determine whether one of the plurality of predefined conditions is present, such as the electronic device being placed in a deactivated or idle state, or if the first battery falls below a defined threshold. Upon detection of one of the plurality of predefined conditions, the switch is moved to the closed position to complete the pathway between the second battery and the first battery, wherein energy stored within the second battery is transferred to the first battery. Once the predefined condition is no longer active, the switch is moved to the open position to sever the connection between the first and second batteries. The switch may further be maintained in the closed position for a set period of time upon detection of the predefined condition to prevent the switch oscillating between the open and closed position about a threshold condition. Once the first and second batteries are depleted, or when the user desires to recharge both batteries, the user can connect the electronic device 13 to an external power source via the charging port, such that energy is transferred to the first battery. In some embodiments, the first battery has charging priority, such that energy is not transferred to the second battery from the external power source until the first battery is at full capacity. In such embodiments, once the first battery is at capacity, the second switch actuates to the closed position to transfer power from the first battery to the second battery. In this manner, the user can extend the lifetime of an existing electronic device 13, minimizing the reliance on an external power source to provide power to the electronic device 13.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly, and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A dual battery power system for electronic devices, comprising:
a first battery operably connected to an electronic device;
a second battery electrically connected to the first battery via a bridging device;
wherein the bridging device comprises a switch selectively movable between an open state and a closed state;
wherein the switch is actuated to the closed state upon detection of the predefined condition by the bridging device;
whereupon actuation of the switch to the closed state, energy stored within the second battery is transferred to the first battery.

2. The dual battery power system of claim 1, wherein the predefined condition is selecting from a group consisting of: placement of the electronic device into an idle state, placement of the electronic device into a deactivated state, and detection of energy storage within the first battery falling below a defined threshold.

3. The dual battery power system of claim 1, further comprising a charging port operably connected to the first battery, such that energy is transferred to the first battery from an external power source via the charging port.

4. The dual battery power system of claim 3, wherein the bridging device further comprises a second switch selectively movable between an open state and a closed state, wherein the second switch is actuated to the closed state when the first battery is at capacity and the charging port is active to transfer energy from the first battery to the second battery.

5. The dual battery power system of claim 3, wherein the charging port is further operably connected to the second battery, such that energy transferred from the external power source is equally distributed to each of the first battery and the second battery.

6. A dual battery power system for electronic devices, comprising:
a first, battery operably connected to an electronic device;
a second battery electrically connected to the first battery via a bridging device;
wherein the bridging device comprises a switch selectively movable between an open state and a closed state;
wherein the switch is actuated to the closed state upon detection of the predefined condition by the bridging device;
whereupon actuation of the switch to the closed state, energy stored within the second battery is transferred to the first battery;
an application installed on the electronic device;
wherein the application includes a plurality of controls configured to set additional predefined conditions.

7. The dual battery power system of claim 6, wherein the predefined condition is selecting from a group consisting of: placement of the electronic device into an idle state, placement of the electronic device into a deactivated state, and detection of energy storage within the first battery falling below a defined threshold.

8. The dual battery power system of claim 6, further comprising a charging port operably connected to the first battery, such that energy is transferred to the first battery from an external power source via the charging port.

9. The dual battery power system of claim 8, wherein the bridging device further comprises a second switch selectively movable between an open state and a closed state, wherein the second switch is actuated to the closed state when the first battery is at capacity and the charging port is active to transfer energy from the first battery to the second battery.

10. The dual battery power system of claim 8, wherein the charging port is further operably connected to the second battery, such that energy transferred from the external power source is equally distributed to each of the first battery and the second battery.

11. The dual battery power system of claim 6, wherein the plurality of controls include a first battery energy threshold control, a timer control, and an idle control.

12. The dual battery power system of claim 11, wherein the timer control defines a set time period during which the switch is actuated to the closed state to transfer energy to the first battery.

13. The dual battery power system of claim 6, wherein the application further displays a current charge level of each of the first battery and the second battery.
